(19) United States
(12) Patent Application Publication
(10) Pub. No.: US 2023/0306317 A1
(43) Pub. Date: Sep. 28, 2023

(54) Computer Technology For Setting And Presenting An Itinerary For A Traveler

(71) Applicant: INTERNATIONAL BUSINESS MACHINES CORPORATION, ARMONK, NY (US)

(72) Inventors: Venkata Vara Prasad Karri, Visakhapatnam (IN); Afroz Khan I, Davanagere (IN); Hemant Kumar Sivaswamy, Pune (IN); Tiberiu Suto, Franklin, NY (US)

(21) Appl. No.: 17/656,755

(22) Filed: Mar. 28, 2022

(51) Int. Cl. G06Q 10/02; G01C 21/36; G01C 21/34; G06F 16/2457

(52) U.S. Cl. CPC G06Q 10/025; G01C 21/3679; G01C 21/343; G06F 16/24578

(57) ABSTRACT

Computer technology for leveraging crowd sourced data to create an experience scoring based itinerary that outputs an itinerary of POI's (points of interest) based on relevancy to the person's interest, scoring experience, weather conditions and other factors relevant to setting the destinations, order and/or scheduling of the traveler's itinerary (for example, a daily schedule for a family on holiday). Also, computer technology for filtration of a set of images unique to a person's profile and taste and stitching these images to suggest a personalized route specific to that person's understanding.

### BACKGROUND

The present invention relates generally to the field of computer technology for setting and presenting a travel itinerary for a user.

U.S. Patent Application Publication US 2021/0133847 (“Mezeaal”) states as follows (reference numerals refer to the Mezeaal document and not this document, some reference numerals omitted for clarity of presentation): “The multiple supplier accounts can be hosted by the travel planning system 110 or a third-party platform (e.g., a social media platform . . . the travel data may be referred to as crowdsourced travel data . . . . The travel planning system 110 can receive travel data from multiple supplier devices, each being utilized to access a supplier account. As is illustrated in FIG. 1, the travel planning system 110 can receive the travel data from N supplier devices: a first reviewer device, a second reviewer device, and so forth up to an N-th supplier device . . . . In response to receiving travel data from one or many supplier devices . . . the travel planning system 110 can update extant travel planning information with the received travel data. Updating the extant travel planning information can include classifying the received travel data into a defined category of travel information, and adding the travel data to extant data in the defined category. For example, such classification can result in a catalog of travel information, such as a catalog of points of interest in a particular region; a catalog of landmarks or other natural formations (e.g., a hidden lake or a waterfall) in a particular region; a catalog of restaurants or other types of eateries (e.g., a three-star restaurant); a catalog of preferred transportation means in a particular region during particular days and/or particular times of day; or similar. In some embodiments, the ingestion module 204 (FIG. 2) can update the received travel data according to aspects described herein. As part of updating the extant travel planning information, the ingestion module 204 can analyze travel data received from supplier account(s) based at least on regions from which the information is received and/or multiple other factors. Such factors can include, for example, previous data and/or trips from a traveler; review data from the traveler; rating data from the traveler; feedback and/or survey data from the traveler; a combination thereof; or similar. In addition, or in some configurations, at least some of the factors can be based on monitoring connected mobile user equipment travelling using various transportation means, such as connected vehicle, bike, scooter, train, airplane, or a combination thereof, and relying on smart infrastructure or other types of infrastructures, or both. Further, or in yet other configurations, at least some other factors can be based on monitoring responses from travelers to their respective traveling plans and respective routing experiences. For the sake of illustration, a routing experience can include what travelers visit the most in a particular region; which transportation mean or platform that most travelers seem to arrive late to; which items travelers buy during specific time of year (e.g., during carnival celebrations in Brazil) or a particular season; what travelers from one region (e.g., travelers from Brazil) drink and/or eat the most when visiting another region (e.g., a location in Argentina); and the like.”

US patent application number 20100302280 (“Szeliski”) states as follows: “Digital photography can allow for a sequence of images to be stitched or glued together to provide for a relatively seamless transition between perspectives of consecutive images from a common location . . . images can be collected from a side-view while traveling along a route, such as a street. Stitching these side-view images together can provide a relatively seamless lateral-view of a traveled route from a sideways perspective . . . . Navigating in human scale, where human scale can comprise street-level imagery, can allow the images of the location to be viewed as one might view the location while walking down a street, for example, turning around to view in a three-hundred and sixty degree scale, and viewing objects in the images with a natural three dimensional-type image perspective.”

### SUMMARY

According to an aspect of the present invention, there is a method, computer program product and/or system that performs the following operations (not necessarily in the following order): (i) receiving a crowd sourced point of interest POI data set including information indicative of: (a) identifying information for a plurality of POIs, (b) for each POI of the plurality of POIs: (1) location, and (2) a plurality of user review scores, and (c) for each user review score, user review score context information including at least weather context information indicating the weather when a reviewer visited the POI; (ii) receiving a traveler/trip data set including at least information indicative of a geographic area and data and time information for a trip by a traveler; (iii) determining, by machine logic, a weight factor for each user review score of the plurality of user review scores of the crowdsourced POI data set, with the determination being based, at least in part on the traveler/trip data set and the user review score context information; and (iv) determining, by machine logic, a plurality of selected POIs for an itinerary for planned travel of the traveler based, at least in part on: (a) the traveler/trip data set, and (b) a plurality of weighted user review scores for the plurality of POIs.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot generated by the first embodiment system; and

FIG. 5 is a screenshot view of a slideshow created by the first embodiment system.

### DETAILED DESCRIPTION

Some embodiments of the present invention are directed to leveraging crowd sourced data to create an experience scoring based itinerary that outputs an itinerary of POI's (points of interest) based on relevancy to the person's interest, scoring experience, weather conditions and other factors relevant to setting the destinations, order and/or scheduling of the traveler's itinerary (for example, a daily schedule for a family on holiday).

Some embodiments of the present invention include consideration of individual user's interest/profile and the dynamic experience scoring as the criteria to populate itineraries in the form of lists that include the experience scoring as a parameter for populating. With respect to the itinerary determination, some other possible relevant factors may, without limitation: weather, health and/or diet. The experience score is obtained by taking into the consideration of persons interest and adjusting the list of itinerary which would maximize the experience of travelling person or set of persons. Some embodiments include generation of an experience score for a point of interest and weather combination or environment condition for travelers with similar travel profiles. For example, if a given person goes on a mountain hike after a hard rain and the terrain is muddy and hard to navigate, then the person may have a very low experience score for this event, but another person who is an experienced extreme mountain climber might find the same conditions challenging and exciting. The given person might score with a high experience score for a nice weather hike, but for the aforementioned climbing enthusiast this might be boring and gather a low score. So, the exact same conditions may have significant difference in experience scores. Accordingly, some embodiments allow for dynamic experience scoring of various venues depending on the expected user satisfaction under various conditions.

In some embodiments, the system will have itinerary populated based on the experience score that focusses on the experience of the traveler, stated for given various condition what could be the best list of itineraries such that the traveler would enjoy the most. For example, based on weather criteria and person's profile some embodiments will adjust the navigation of POI so that person can enjoy the most. Some embodiments collect and store experience scores for future recommendation and/or the other travelers. Some embodiments filter out a set of images unique to a person's profile and taste and stitch these images to suggest a personalized route specific to that person's understanding. For example, as travelers continue from the source to destination between venues, the coordinates may be used in some embodiments to obtain geo-tagged crowd sourced images ahead of the travelers reaching particular landmarks along the way and this may be indicated on the device in the direction that the travelers should look to view an upcoming landmark. Some embodiments utilize NLP (natural language parsing) and/or NLU (natural language understanding) to make suggestions to a person based on his/her preferred mealtimes and the choice of the restaurant considering the profile of the user. Some embodiments use experience scoring for listing out POI's, and then stitch that route using interactive images obtained from crowd sourcing for ease of navigation. Some embodiments also have an AI component utilized for an example use case.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

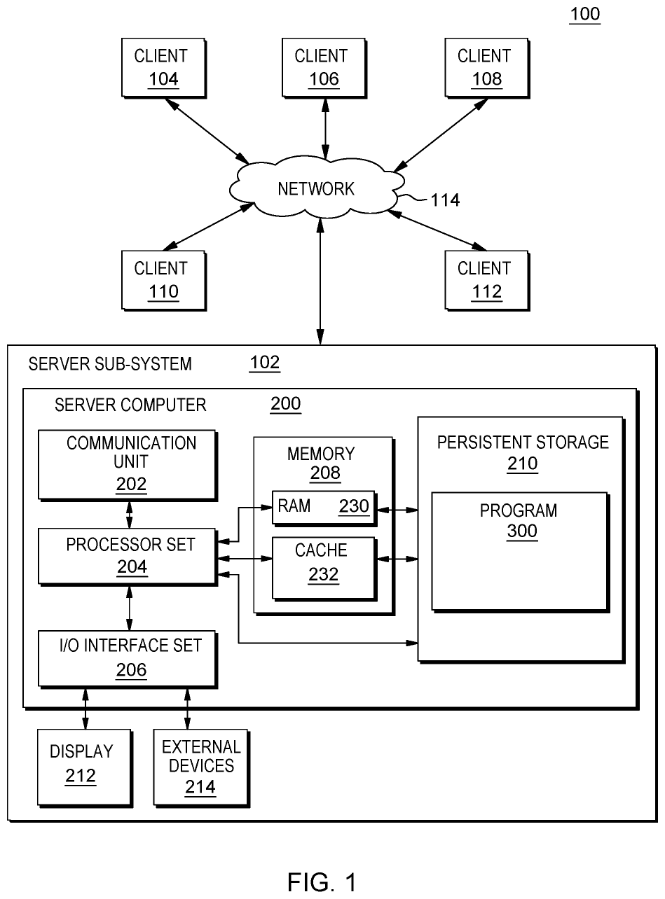

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

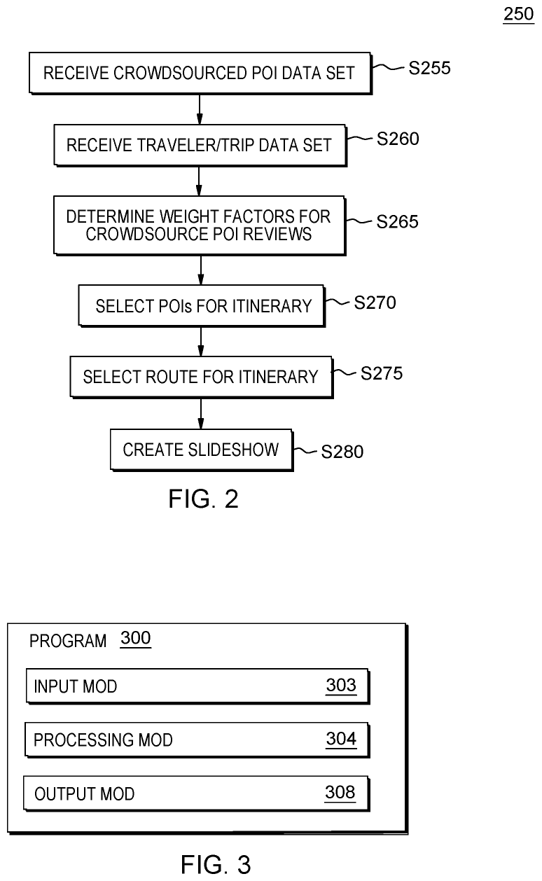

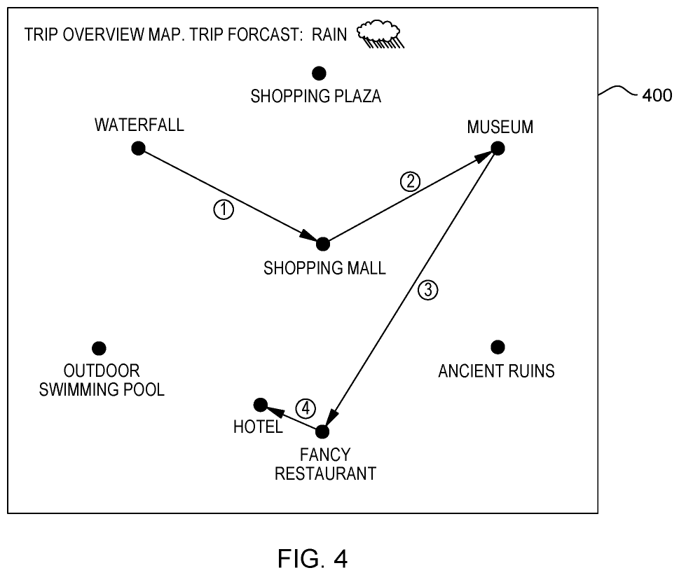

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where input module (“mod”) 303 receives a crowd sourced POI data set including information of: (i) identifying information for a set of POIs; and (ii) for each POI: (a) location, and (b) a set of user review scores; and (iii) for each user review score, user review score context information including: (a) weather context information indicating the weather when the user visited the POI, and (b) traveler group context information indicating whether the user was travelling as an individual, in a family group or in a business group. Alternatively, other embodiments may include additional, or different, types of context information. Generally speaking, additional context information will be helpful in enhancing quality of the performance of the itinerary setting operations discussed below. This embodiment includes limited user review context information to keep things simple and promote quicker reader understanding of certain inventive concepts underlying various embodiments of the present invention.

In this embodiment, the POIs are limited to a city named Cityopolis. As shown in screenshot 400, there are seven POIs in Cityopolis as follows: (i) waterfall, (ii) shopping plaza, (iii) museum, (iv) outdoor swimming pool, (v) shopping mall, (vi) fancy restaurant and (vii) ancient ruins. There is also a hotel in Cityopolis, but it is not considered as a POI for obvious reasons. In this example, the user ratings and associated user group context (individual/family/business group) of the crowdsourced POI data set come from a user review site hosted at client sub-system 104. In this example, the weather context information of the crowdsourced POI data set comes from historical weather data repository hosted at client sub-system 106 and is integrated with the user reviews based on the individual user review timestamps.

Processing proceeds to operation S260, where input mod 303 receives a traveler/trip data set from client subsystem 110, which is the smart phone a family member planning a trip to Cityopolis for their family. The family will have one day in Cityopolis and will be staying at the hotel mentioned above. The traveler trip data set includes: (i) the place where the traveler will be (that is, Cityopolis); (ii) the date of travel (that is, tomorrow); (iii) travel requirements (in this example, the family member says that the itinerary must begin at the waterfall); (iv) travel preferences (in this example, the travel planner/family member would prefer that the family be be close to the hotel after darkness falls); and (v) members of travel party (in this example, that is the family).

Processing proceeds to operation S265, where processing mod 304: (i) selects which user reviews to consider when setting the itinerary; and (ii) provides weight factors for each selected POI user review score in the POI data set. Under the terminology of this document, both of these steps are considered as “weighting” or providing “weight factors.” This is because, the user reviews that are not selected for consideration have a weight factor of zero. In some embodiments, each user review may be binarily assigned a weight factor of zero or one, with no weight factors that are in-between. In other embodiments, including the embodiment now under discussion, at least some of the user reviews may be assigned weight factors between zero and one. In other embodiments, there may even be weight factors less than zero and/or greater than one.

The weighting algorithm of processing mod 304 for this particular example will now be described in detail in this paragraph. Before plunging into the algorithm, it is noted that rain is forecast as a near certainty for the day that the family will visit Cityopolis. The algorithm is as follows: (i) any user review where the user context information indicates that it was not raining will not be considered at all (that is, an assigned weight factor of zero); (ii) any rainy day user review that is associated with “business group” type traveler context information will be assigned zero weight (that is, not considered); (iii) any rainy day user review that is associated with “individual” type traveler context information will be assigned a weight factor of 0.1; and (iv) any rainy day user review that is associated with “family group” type traveler context information will be maintain a 1.0 weight factor (that is, undiscounted consideration). As can be appreciated from this example algorithm, different context factors affect the weighting in different ways, and the general idea is to try to model what the actual traveler would consider as relevant is the actual traveler were to personally themself sit down and look at all the user reviews themselves. The present invention is not limited to any specific and particular scheme for determining weight factors—rather, the focus is on the idea that different types of context factors are the input that is used to determine weight factors as an output.

Processing proceeds to operation S270, where processing mod 304 determines the POIs, from among all the POIs of Cityopolis, that will be on the itinerary for the family's day in Cityopolis.

In this example, the processing logic considers first the traveler's requirements. As mentioned above, the family requires that the trip begin at the waterfall, so this is the first item selected for the itinerary.

In this example, the processing logic next considers the family's preference of being close to the hotel after dark. As shown in screen shot 400, the only POI that is located near the hotel is the fancy restaurant. For that reason, the fancy restaurant is selected to be the last item on the itinerary. In this simple embodiment, context information is not considered in conjunction with the traveler's stated POI preferences. Alternatively, preferences may be balanced against context information in deciding which preferences should be accommodated on the itinerary.

With two itinerary items set, it is determined that there is sufficient time for two more POIs to be added to the itinerary. These are selected by consideration of the weighted context information. The shopping plaza and ancient ruins have generally poor rainy day user review ratings. Primarily for this reason, mod 304 does not select these two Cityopolis POIs for the itinerary. The outdoor swimming pool has generally poor user reviews from family groups (in this example the reason for that is that the pool does not have good supervision for children). So, the outdoor swimming pool also does not make the itinerary. On the other hand, the shopping mall and museum have good rainy day ratings and good family ratings. The selected itinerary that falls out of this analysis is as follows: (i) waterfall; (ii) shopping mall; (iii) museum; (iv) fancy restaurant; and (v) hotel. (See screen shot 400 for a map showing the itinerary.)

Processing proceeds to operation S275, where processing mod selects a route is selected for the itinerary in conjunction with client sub-system 112, which provides street map information for Cityopolis. This route is shown in screen shot 400. The itinerary and route are communicated to the user by output mod 308.

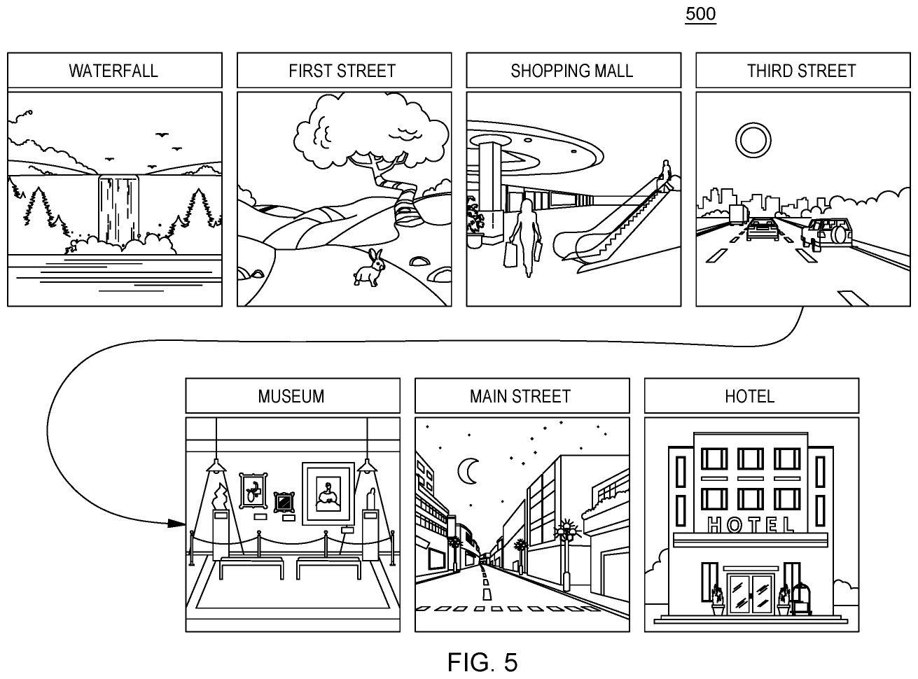

Processing proceeds to operation S280, where processing mod 304 stitches together photographs and/or videos of the POIs and also the roads connecting them by the selected route. This is shown at slideshow 500 of FIG. 5.

### III. Further Comments and/or Embodiments

Some embodiments of the present invention recognize the following facts, potential problems and/or potential areas for improvement with respect to the current state of the art: (i) when travelers and tourists arrive at a new destination, they often find it challenging to navigate this unfamiliar area in the most effective way; and/or (ii) travelers enjoy looking at maps and slide shows of their travel routes and planned travel routes.

Some embodiments of the present invention recognize the following facts, potential problems and/or potential areas for improvement with respect to the current state of the art: (i) the probability of a person landing on place which is unknown is very high; (ii) the lack of familiarity of a place often leads to anxiety and frustration; and/or (iii) when travelers arrive at an unfamiliar location, it may be challenging to determine which points of interest to visit and which sequence to visit them in that will provide the best experience for the traveler.

Some embodiments of the present invention may include one, or more, of the following operations, features, characteristics and/or advantages: (i) includes a system that allows travelers to make the most of their vacation time; (ii) guides travelers through visiting points of interest and landmarks that may be of interest to them in an optimized way based on their profiles; (iii) the system dynamically determines how to adjust the itinerary depending on weather conditions and how those may differently affect the experience of a particular landmark; and/or (iv) makes a suggestion to the traveler which is within a walkable distance from the travelers starting location (for example, a person has travelled from one location to an another location, which is presumably new to him, and is based on the person's profile).

Some embodiments of the present invention may include one, or more, of the following operations, features, characteristics and/or advantages: (i) assists travelers with generated customized maps using their interests as a criteria, with images and itineraries, populated from crowdsourced data (crowd sourced data herein refers to the inclusion of geotagged images, weather conditions, experience score and feedback score); (ii) the system contains a learning feature that adjusts future recommendations by incorporating feedback, including multi-point data elements gathered during travel; and/or (iii) according to some embodiments of the present invention, a user is guided via crowd sourced data by using GPS coordinates, a compass, geotagged images and experience score.

According to some embodiments of the present invention: (i) the user uses the system to suggest a location of interest and a POI map with crowd sourced data is provided; (ii) a personalized map with images populated at each reference point along the route is provided to the user; and/or (iii) cloud sourced images are obtained and populated on the user's device along the route along with the users experience score and weather conditions.

A method according to an embodiment of the present invention includes the following operations (not necessarily in the following order): (i) utilizes an experience score collected from the previous travelers who already visited the place(s) to be recommended; (ii) a system comprising of techniques utilizing the crowd sourced data to suggest places of interest, based on the person's profile; (iii) crowd sourced data here in refers to geotagged images, GPS (global positioning system) co-ordinates of travelers, stay duration, and GPS route; (iv) consists of a technique which uses weather of the location to be recommended to determine the order of the itineraries listed; (v) comprises a technique which uses images obtained from crowd sourced images and populated along the route of the itinerary for better comfort and ease of travelling; and (vi) considers; (a) building a person's profile and context pertaining to activities, travelling pattern, places visited, interests and so on, (b) GPS and compass information available from the person's handheld device, (c) crowd sourced images with information of coordinates and location tags, (d) expected weather of the locations present in the itinerary, and (e) a network connection with an optimum baud rate.

A method according to an embodiment of the present invention includes the following operations (not necessarily in the following order): (i) the user opts into the systems privacy terms; (ii) the travelers itinerary, destination hotel and duration of stay can be parsed from email confirmations of bookings where this would be done by processing he transaction through IBM Watson NLP (natural language processing) and NLU (natural language understanding); (iii) once an upcoming travel is booked, the system starts data analysis of the destination even before the traveler arrives at the destination; (iv) based on the weather forecast for the destination and the probability of sunny, rainy or inclement weather, the system will build a list of potential POI (points of interest) for the traveler and order them by the expected experience score, highest to lowest, based on the traveler's interests in their profile, crowdsourced scores of POI of other travelers with a similar profile and expected weather events that can impact scores; and (v) if there are multiple travelers traveling together, the system will allow setting different weights for interests contained in each of their profiles, allowing the combined scoring of the different POIs to consider the most important preferences of each passenger in the sorting algorithm.

A method according to an embodiment of the present invention includes the following operations (not necessarily in the following order): (i) the system will detect and remove POI from the list that are not feasible for the traveler(s) during the particular stay (for example, venues that are not available during the travelers' stay at destination, or ones that do not match any of the interests of the travelers, etc. would not show up in the list); (ii) the operation in (i) above would prevent travelers from trying to request a venue that would not be logistically possible, etc.; (iii) the POI that remains in the list after processing of the above operations, the system will assemble an itinerary for the stay including the highest scoring POIs detected; (iv) additional criteria is also used for scheduling of the particular venues, to ensure the visits are scheduled during times that the particular exhibits are open and that the travel from one venue to another is feasible; (v) IBM Watson NLP and NLU may be used to scour different provider's sites to compile when the times the venues are open and the travel logistics between venues; and (vi) the POI would appear in a calendar timeline within the app along with the expected experience scores for the various POI.

A method according to an embodiment of the present invention includes the following operations (not necessarily in the following order): (i) outside of the timeline described above, other POI may be shown that may not have had a high enough score to be included into the timeline, however, if the user wishes to exchange a POI from here and bring it to the timeline, the app would allow the user to drag and drop and replace one POI with another; (ii) once the user reviews and accepts the timeline itinerary provided, the system will automatically book any services that require reservations for the exact period in time that the traveler would be there; (iii) the system will continually monitor for weather forecast changes or other events that may impact the timeline and if any of these are detected, it would automatically try to determine an adjustment to the timeline that would be appropriate (for example, if a canoe trip is scheduled for Thursday and Thursday's forecast changes and calls for rain, it may suggest replacing that day's POI with the highest score POI that provides an indoors venue, such as a museum, etc.); and (iv) if the user accepts a replacement POI, the system would also automatically cancel the relevant event and book the alternate.

A method according to an embodiment of the present invention includes the following operations (not necessarily in the following order): (i) during visits to the various POI, the directions can be obtained by utilizing the integrated electronic compass for walking directions or the system may integrate with public transportation systems such as bus, metro or private car services to allow multiple modes of transportation between venues according to users preferences; (ii) GPS coordinates, current position, destination and the direction which the user is facing is fed to the proposed method of systems; (iii) the source to destination map is then formed and the map is sliced into smaller segments in order to suggest interesting landmarks that may be passed along the way; and (iv) as travelers continue from the source to destinations between venues, the coordinates may be used to obtain geo tagged crowd sourced images ahead of the travelers reaching particular landmarks along the way and this may be indicated on the device in the direction that the travelers should look to view an upcoming landmark.

A method according to an embodiment of the present invention includes the following operations (not necessarily in the following order): (i) if a user is running early going to a particular venue and is projected to arrive before the venue is open, the system may suggest some detours along the way to fill up the extra time with other areas of interest that may fit the amount of extra time (for example, if the travelers are on the way to the Louvre museum opening at 10 AM and they are projected to arrive by 9 AM, and the weather outside is sunny, the system may suggest stopping at the nearby Champs-Élysées for an hours walk by some landmarks and shops of interest; (ii) once the user completes a visit to a venue, the user can select an experience score on a rate of 1 to 100; and (iii) the score noted in (ii) above will be correlated not only to the venue but also to the weather, time of year and other conditions encountered during the visit.

As an example, and referencing the method paragraphs above, visiting the Gardens of the Champs-Élysées during sunny weather with an outdoor temp of 70 F might give an experience score of 95, but during rain and ambient temp of 50 F it might be an experience score of 40 (on a scale of 1 to 100). However, a visit to the Louvre Museum might give an experience score of 85 in rainy weather (since it's indoors) but during sunny weather it might only give an experience score of 80 (because people might rather be outside on such a nice day then being indoors in a museum, etc.). Also, if a traveler has only one day to visit Paris, the system can automatically determine that the weather forecast is rainy in the morning and sunny in the afternoon and it can generate the itinerary to include the museum visit during the rainy time and the outdoor places during the sunny weather, etc. This could be determined by including rated experience scores from past travelers who have visited the various landmarks in the different weather conditions, etc.

A method according to an embodiment of the present invention includes the following operations (not necessarily in the following order): (i) the system may also allow users to set their dietary preferences and will take into account mealtimes and availability of a restaurant serving users preferred food at a logistically available location from venues booked before and after the meal; (ii) the system will ensure that the user may not miss a meal due to venues scheduled at an inconvenient time and place; and (iii) the system may also use IBM Watson NLP and NLU to determine from the online information if a restaurant requires reservations to ensure that when the user arrives at the restaurant, there will be available seating.

An additional feature of some embodiments of the present invention will now be discussed. More specifically, in some embodiments, the computer system factors in a consideration of diverging and converging paths for a subset of the travelers at certain times when no event with a satisfactory score for all participants can be located by the system. To give an example, consider a family of four traveling together, two parents and two teenagers, ages 18 and 19. During the second day of the trip, there are 3 potential events between 2 and 4 PM. In this instructive example: (i) Symphony orchestra (85 and 95 score for the parents, 0 and 0 for the children) (42.5 overall score); (ii) Theme park roller coaster ride (10 and 10 score for the parents, 80 and 90 for the children) (47.5 overall score); and/or (iii) Picnic in the park (30 and 40 score for the parents, 20 and 10 score for the children) (25 overall score). Further consider that the operative threshold value is an overall score of 50 or higher and none of the above events match the threshold. However, if the machine logic of the computer system considers the scores of the parents only for the first event and the score of the kids only for the second event and if there is a possibility where their path can diverge for a particular event and converge later (including transportation logistics for diverge and converge portions, age restrictions constraints, for example kids under 16 not allowed in theme park without adult, etc.), then the computer system will detect this, and, when feasible, offer the diverge/converge possibility as a suggestion.

### Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
receiving a crowd sourced point of interest POI data set including information indicative of: (i) identifying information for a plurality of POIs, (ii) for each POI of the plurality of POIs: (a) location, and (b) a plurality of user review scores, and (iii) for each user review score, user review score context information including at least weather context information indicating the weather when a reviewer visited the POI;
receiving a traveler/trip data set including at least information indicative of a geographic area and data and time information for a trip by a traveler;
determining, by machine logic, a weight factor for each user review score of the plurality of user review scores of the crowdsourced POI data set, with the determination being based, at least in part on the traveler/trip data set and the user review score context information;
determining, by machine logic, a plurality of selected POIs for an itinerary for planned travel of the traveler based, at least in part on: (i) the traveler/trip data set, and (ii) a plurality of weighted user review scores for the plurality of POIs;
receiving first user input from the traveler; and
responsive to the receipt of the first user input, replacing a first selected POI of the plurality of selected POIs in the itinerary with a first POI of the plurality of POIs.

2. The CIM of claim 1 further comprising:
determining a route for the traveler among and between the plurality of selected POIs of the itinerary.

3. The CIM of claim 1 further comprising:
stitching together a plurality of photographs and/or videos, including images of the selected POIs of the plurality of POIs to form a slideshow for presentation to the traveler.

4. The CIM of claim 1 wherein the user review score context information further includes traveler group context information.

5. The CIM of claim 1 wherein each weight factor is equal to one of the following values: zero or one.

6. The CIM of claim 1 wherein:
the traveler is a plurality of individuals planning to travel together; and
the determination of the itinerary for planned travel of the traveler based includes separating the traveler into at least two portions, with each portion including at least one individual, and with each portion of the traveler going to different locations as part of the itinerary.

7. A computer program product (CPP) comprising:
a set of storage device(s); and
computer code stored collectively in the set of storage device(s), with the computer code including data and instructions to cause a processor(s) set to perform at least the following operations:
receiving a crowd sourced point of interest POI data set including information indicative of: (i) identifying information for a plurality of POIs, (ii) for each POI of the plurality of POIs: (a) location, and (b) a plurality of user review scores, and (iii) for each user review score, user review score context information including at least weather context information indicating the weather when a reviewer visited the POI,
receiving a traveler/trip data set including at least information indicative of a geographic area and data and time information for a trip by a traveler,
determining, by machine logic, a weight factor for each user review score of the plurality of user review scores of the crowdsourced POI data set, with the determination being based, at least in part on the traveler/trip data set and the user review score context information,
determining, by machine logic, a plurality of selected POIs for an itinerary for planned travel of the traveler based, at least in part on: (i) the traveler/trip data set, and (ii) a plurality of weighted user review scores for the plurality of POIs,
receiving first user input from the traveler, and
responsive to the receipt of the first user input, replacing a first selected POI of the plurality of selected POIs in the itinerary with a first POI of the plurality of POIs.

8. The CPP of claim 7 wherein the computer code further includes instructions for causing the processor(s) set to perform the following operation(s):
determining a route for the traveler among and between the plurality of selected POIs of the itinerary.

9. The CPP of claim 7 wherein the computer code further includes instructions for causing the processor(s) set to perform the following operation(s):
stitching together a plurality of photographs and/or videos, including images of the selected POIs of the plurality of POIs to form a slideshow for presentation to the traveler.

10. The CPP of claim 7 wherein the user review score context information further includes traveler group context information.

11. The CPP of claim 7 wherein each weight factor is equal to one of the following values: zero or one.

12. The CPP of claim 7 wherein:
the traveler is a plurality of individuals planning to travel together; and
the determination of the itinerary for planned travel of the traveler based includes separating the traveler into at least two portions, with each portion including at least one individual, and with each portion of the traveler going to different locations as part of the itinerary.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving a crowd sourced point of interest POI data set including information indicative of: (i) identifying information for a plurality of POIs, (ii) for each POI of the plurality of POIs: (a) location, and (b) a plurality of user review scores, and (iii) for each user review score, user review score context information including at least weather context information indicating the weather when a reviewer visited the POI,
receiving a traveler/trip data set including at least information indicative of a geographic area and data and time information for a trip by a traveler,
determining, by machine logic, a weight factor for each user review score of the plurality of user review scores of the crowdsourced POI data set, with the determination being based, at least in part on the traveler/trip data set and the user review score context information,
determining, by machine logic, a plurality of selected POIs for an itinerary for planned travel of the traveler based, at least in part on: (i) the traveler/trip data set, and (ii) a plurality of weighted user review scores for the plurality of POIs,
receiving first user input from the traveler, and
responsive to the receipt of the first user input, replacing a first selected POI of the plurality of selected POIs in the itinerary with a first POI of the plurality of POIs.

14. The CS of claim 13 wherein the computer code further includes instructions for causing the processor(s) set to perform the following operation(s):
determining a route for the traveler among and between the plurality of selected POIs of the itinerary.

15. The CS of claim 13 wherein the computer code further includes instructions for causing the processor(s) set to perform the following operation(s):
stitching together a plurality of photographs and/or videos, including images of the selected POIs of the plurality of POIs to form a slideshow for presentation to the traveler.

16. The CS of claim 13 wherein the user review score context information further includes traveler group context information.

17. The CS of claim 13 wherein each weight factor is equal to one of the following values: zero or one.

18. The CS of claim 13 wherein:
the traveler is a plurality of individuals planning to travel together; and
the determination of the itinerary for planned travel of the traveler based includes separating the traveler into at least two portions, with each portion including at least one individual, and with each portion of the traveler going to different locations as part of the itinerary.
